(19) United States
(12) Patent Application Publication
(10) Pub. No.: US 2024/0274842 A1
(43) Pub. Date: Aug. 15, 2024

(54) ROTOR AND SUPERCHARGER ARRANGEMENT

(71) Applicant: BorgWarner Inc., Auburn Hills, MI (US)

(72) Inventor: Sebastian Dauscher, Immesheim (DE)

(21) Appl. No.: 18/221,489

(22) Filed: Jul. 13, 2023

(30) Foreign Application Priority Data
Feb. 9, 2023 (DE) 102023103200.3

(51) Int. Cl. H01M 8/04111; F04D 17/10; F04D 25/06

(52) U.S. Cl. CPC H01M 8/04111; F04D 17/10; F04D 25/06; H01M 2250/20

(57) ABSTRACT

A rotor (23) of an electrically driven supercharger compressor (7) includes a rotor centre part (27) and first and second shaft end parts (31, 33). The rotor centre part (27) includes a shaft portion (29) including a permanent magnet (35), and the rotor centre part (27) is configured as a rotating armature of an electric motor (21). The first and second shaft end parts (31, 33) are arranged on opposing end faces of the rotor centre part (27) and are connected to the rotor centre part (27) in a rotationally engaged manner. A basic shape of the first shaft end part (31) and a basic shape of the second shaft end part (33) are mirror-symmetrical to one another.

### CROSS-REFERENCE TO RELATED APPLICATIONS

This application claims priority pursuant to 35 U.S.C. 119(a) to German Patent Application No. 102023103200.3 filed Feb. 9, 2023, which application is incorporated herein by reference in its entirety.

### BACKGROUND

The invention relates to a rotor of an electrically driven supercharger compressor and a supercharger arrangement comprising a rotor of this type.

A fuel cell system can be provided in a vehicle, for example a car, train, aircraft or vessel. Electrical energy is generated in the fuel cell system, for example by means of hydrogen, in order to drive the vehicle.

The fuel cell system comprises a fuel cell unit which is fed with hydrogen gas. A supercharger can be provided to supply fresh air or oxygen, which reacts with the hydrogen. The supercharger comprises an electrically driven compressor to compress the oxygen. There are configurations in which the electric drive is assisted by an exhaust-gas-driven turbine.

### SUMMARY

The object of the invention is to provide a simple-to-manufacture rotor for an electrically driven supercharger compressor.

The object is achieved by a rotor having the features of claim 1.

The rotor of an electrically driven supercharger compressor is provided with a rotor centre part comprising a shaft portion comprising a permanent magnet, wherein the rotor centre part is configured as a rotating armature of an electric motor, and a first and second shaft end part. The shaft end parts are arranged on opposing end faces of the rotor centre part and are connected to the rotor centre part in a rotationally engaged manner, wherein a basic shape of the first shaft end part and a basic shape of the second shaft end part are mirror-symmetrical to one another.

The rotor is used in a supercharger compressor and is a rotating machine component of the supercharger compressor. A supercharger compressor of this type advantageously forms part of a supercharger arrangement for supplying air in a fuel cell system. The supercharger compressor, which is driven by an electric motor, compresses the air conveyed to the fuel cell. As the rotating armature of the electric motor, the rotor centre part exerts a driving effect by means of the shaft end parts, which are connected to the rotor centre part and form a shaft. The compressor wheel, which is arranged on the shaft, of the supercharger compressor is driven by the movement of the shaft.

Arranged on the rotor centre part, in particular the shaft portion, is at least one permanent magnet which, for example, can be configured so as to be sleeve-shaped and arranged on the shaft portion. In an alternative configuration, a plurality of permanent magnets are provided, which are arranged side-by-side along the circumference of the shaft portion. A stator with windings is arranged around the permanent magnet as a further component of the electric motor. A time-varying current flow induces a time-varying magnetic field in the windings. As a result of the interaction between the magnetic fields of the windings and the permanent magnet, the armature is subject to torque and rotates.

The basic shape is the three-dimensional main shape of the shaft end parts, not taking into account any surface structures provided in certain regions which may arise, for example, from manufacturing tolerances, balancing or damage. Pattern-like surface structures, for example grooves, circumferential notches or threads, also do not form part of the basic shape.

In a configuration, the shape of the first shaft end part and the shape of the second shaft end part differ from the respective basic shapes thereof only as a result of partial material removal. In this case, discrepancies in the mirror symmetry of the shapes arise merely as a result of partial material removal from one of the shapes only, for example as a consequence of balancing. Alternatively, the respective basic shapes correspond to the shapes. This applies in particular in the case of a smooth, structureless surface.

In a configuration, the shaft end parts are manufactured from the same blanks which take the form of the basic shape. Manufacturing is carried out by means of material removal processes and typically comprises thread cutting and/or balancing (by means of material removal).

Nevertheless, the shape of the first shaft end part and the shape of the second shaft end part at least substantially correspond to the respective basic shape. Differences between the actual shape and the basic shape only take the form of surface structures. The degree of correspondence should be at least 90%, in particular at least 95%.

Advantageously, the rotor centre part is also mirror-symmetrical or substantially mirror-symmetrical. This means that tolerances caused by manufacturing and/or discrepancies which do not restrict function can arise, for example at the attachment regions for the shaft end parts, but a person skilled in the art would nevertheless still consider the rotor centre part to be mirror-symmetrical. The rotor centre part, with the shaft end parts fastened thereto, is also at least substantially mirror-symmetrical.

In a configuration, the first and second shaft end parts each have a thread, one of which is a left-hand thread and the other a right-hand thread. Alternatively or in addition, a left-hand thread and a right-hand thread are provided on opposing sides on the rotor centre part. The impellers can be fastened to the shaft end parts by means of screw connections. A first impeller and a second impeller can be fastened in a rotationally engaged manner to the first and second shaft end parts respectively. In a configuration, the first and second shaft end parts each have an axially extending cavity in such a way that they are configured so as to be cup-shaped. The rotor centre part can also be hollow. The first impeller is connected to the first shaft end part or the rotor centre part by means of a tie bar projecting into the cavity, and/or the second impeller is connected to the second shaft end part or the rotor centre part by means of a further tie bar projecting into the cavity.

Threads are also provided on the impellers in a configuration. In comparison with conventional rotors, no tie rod is required during installation if impellers and shaft nuts for fastening the radial bearing parts are arranged on the same thread.

In a configuration, the rotor comprises a compressor wheel as a first impeller, which is arranged on the first shaft end part, and a turbine wheel as a second impeller, which is arranged on the second shaft end part. A rotor of this type is used in a supercharger arrangement in which the electrically driven supercharger compressor is turbine assisted. The turbine wheel of the turbine is driven by a flow of exhaust gas and assists the electric drive for the compressor wheel.

In a configuration, the rotor comprises a first compressor wheel as a first impeller, which is arranged on the first shaft end part, and a second compressor wheel as a second impeller, which is arranged on the second shaft end part. A rotor of this type is used in a supercharger arrangement in which the electrically driven supercharger compressor is of a two-stage configuration, i.e. it has two compressor wheels for two compressor stages.

In a configuration, the first and second shaft end parts are configured in such a way that the rotor can be borne on the shaft end parts. The latter have bearing regions which rotate in the bearings. The bearing arrangement comprises radial and/or axial bearings. The former can be configured as air bearings.

Due to the mirror-symmetrical construction, the shaft with the permanent magnet of the electric motor armature in the centre has, on each side, two radial bearing regions, which are symmetrically constructed and arranged and on which the rotor can be borne, in such a way that the shaft end parts can be manufactured in an identical manner. This results in relatively low costs in the case of relatively high quantities. The rotor centre part is also constructed in a simple manner and may be provided with a thread on each side, one of which is a left-hand thread and the other a right-hand thread, in order to assemble the components of the rotor.

The mirror-symmetrical rotor construction simplifies design and manufacture. Fewer components are required than in conventional rotors. These aspects reduce complexity and costs.

### BRIEF DESCRIPTION OF THE DRAWINGS

A plurality of exemplary embodiments will be explained in greater detail below with reference to the drawings, in which:

FIG. 1 shows a schematic view of an exemplary embodiment of a fuel cell system; and

FIG. 2 shows a sectional view through an exemplary embodiment of a rotor.

In the figures, identical or functionally equivalent components are provided with the same reference signs.

### DETAILED DESCRIPTION

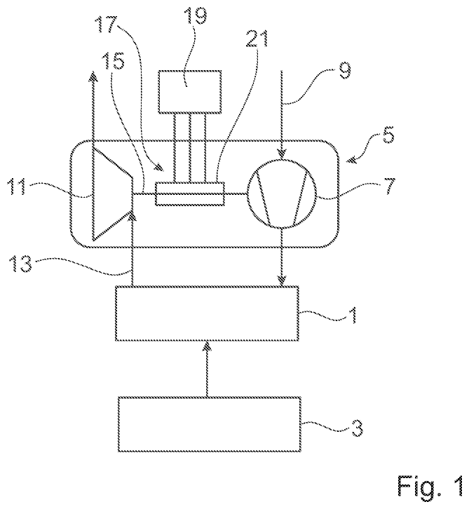

FIG. 1 shows a schematic view of an exemplary embodiment of a fuel cell system.

The fuel cell system comprises a fuel cell unit 1, which is coupled on the input side to a hydrogen tank 3, from which hydrogen is conducted, as fuel, into the fuel cell unit 1.

The fuel cell unit 1 is coupled to a supercharger arrangement 5, which conveys air to the fuel cell unit 1. In the fuel cell unit 1, the reaction between hydrogen and oxygen from the supplied air causes the chemical energy of hydrogen and oxygen to be converted into electrical energy which can be used to drive a vehicle.

The supercharger arrangement 5 comprises a compressor 7, which has previously also been referred to as a supercharger compressor. It is configured to compress and convey an air flow 9 for the fuel cell unit 1.

A turbine 11 can be driven by a fuel cell exhaust gas flow 13. The compressor wheel and turbine wheel of the turbine 11 or of the compressor 7 are connected to one other via a shaft 15, in such a way that the rotation of the turbine wheel is transferred to the compressor wheel. An electric drive 17 drives the shafts 15 and thus the compressor wheel of the compressor 7 in a turbine-assisted manner.

The electric drive 17 comprises an electric motor 21, which is configured to drive both the compressor wheel and the turbine wheel in such a way that air is conveyed to the fuel cell unit 1. A control circuit 19 of the electric drive 17 controls the electric motor 17. Power is also supplied to the electric motor 21 via the control circuit 19, the power supply being dependent on the amount of fuel cell exhaust gas flowing into the turbine 11, and the desired performance of the compressor 7.

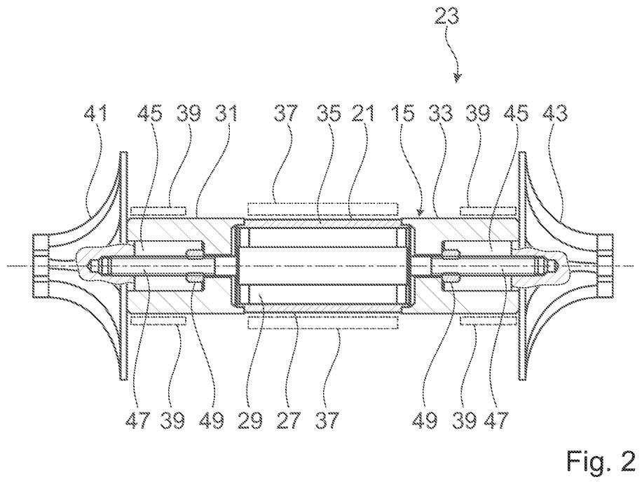

FIG. 2 shows a sectional view through an exemplary embodiment of a rotor 23. The rotor 23 is the rotating machine component of a supercharger arrangement 5 comprising a compressor 7 for supplying air in a fuel cell system.

The rotor 23 comprises a hollow rotor centre part 27 and first and second shaft end parts 31, 33, which are arranged at opposing end faces of the rotor centre part 27 and are connected in a rotationally engaged manner to the rotor centre part 27 in such a way that they form a shaft 15. The connection can, for example, take the form of a press fit or a screw connection. The rotor centre part 27 comprises a shaft portion 29, on which a permanent magnet 35 is arranged, wherein the rotor centre part 27 is configured as an armature of an electric motor 21. The electric motor 21 further comprises a stator 37, shown schematically in broken lines. The interaction between the magnetic field of the permanent magnet 35 and the time-varying magnetic field in windings of the stator 37 causes the shaft 15 to rotate, driven by the electric motor 21.

The first and second shaft end parts 31, 33 are configured in such a way that the rotor 23 can be borne on the shaft end parts 31, 33. The rotor is borne radially by means of air bearings 39 (shown schematically in broken lines) which are arranged on both sides of the rotor centre part 27.

A first impeller 41 and a second impeller 43 are fastened in a rotationally engaged manner to the first and second shaft end parts 31, 33 respectively. For this purpose, the first and second shaft end parts 31, 33 each have a cavity 45 extending axially in the direction of the rotor centre part, in such a way that the first and second shaft end parts 31, 33 each have a cup-like shape, through the base of which journals of the rotor centre part 27 extend. The impellers 41, 43 are connected to the shaft 15 by means of rod-shaped tie bars 47, which engage in the cavities 45. The connection can take the form of a screw connection with the journals in the cup base region of the shaft end parts 31, 33 or in the shaft end parts 31, 33. The thread in one of the journals or shaft end parts 31, 33 is a right-hand thread and the thread in the other journal or shaft end part 31, 33 is a left-hand thread. The tie bars 47 also have threads running in opposing directions. Impellers 41, 43 and shaft nuts 49 are arranged on the same thread for fastening the radial bearing parts.

The shape of the first shaft end part 31 and the shape of the second shaft end part 33 substantially correspond to the basic shapes thereof, which are mirror-symmetrical to one another. The shape of the first shaft end part 31 and the shape of the second shaft end part 33 can deviate slightly from the basic shape as a result of material removal. This material removal can be caused in particular by balancing and/or manufacturing tolerances. Minor discrepancies compared to the basic shape, which lead to differences in the shaft end parts 31, 33, for example as a result of circumferential notches, also do not impair the mirror symmetry of the basic shapes. Discrepancies in the threads, for example differences resulting from misalignment, or in pitch or direction of rotation, also do not impair the mirror symmetry of the basic shapes.

The shaft 15, formed by assembling the rotor centre part 27 and the shaft end parts 31, 33, is rotationally symmetrical or substantially rotationally symmetrical relative to a plane perpendicular to the axis of rotation and at the centre of the shaft. This relates to the above-mentioned material removal from the shaft end parts 31, 33, manufacturing tolerances and tolerances which are not significant with regard to function.

The rotor 15 forms part of a supercharger arrangement 5 for supplying air in a fuel cell system, as described by way of example in connection with FIG. 1. In an exemplary embodiment, one of the impellers 41, 43 is configured as a turbine wheel. The other impeller 41, 43 is configured as a compressor wheel. In this supercharger arrangement 5, the electric drive is turbine assisted.

In an alternative exemplary embodiment of the supercharger arrangement 5, both impellers 41, 42 are configured as compressor wheels. This supercharger arrangement 5 has a two-stage compressor.

The features indicated above and in the claims, as well as those which can be inferred from the drawings, can be advantageously achieved both individually and in various combinations. The invention is not limited to the exemplary embodiments described, but can be modified in various ways within the scope of competence of a person skilled in the art.

### REFERENCE SIGNS

1 fuel cell unit
3 hydrogen tank
5 supercharger arrangement
7 compressor
9 air flow
11 turbine
13 fuel cell exhaust gas flow
15 shaft
19 control circuit
21 electric motor
23 rotor
27 rotor centre part
29 shaft portion
31, 33 shaft end part
35 permanent magnet
37 stator
39 air bearing
41, 43 impeller
45 cavity
47 tie bar
49 shaft nut

What is claimed is:

1. A rotor of an electrically driven supercharger compressor, the rotor comprising
a rotor centre part comprising a shaft portion comprising a permanent magnet, wherein the rotor centre part is configured as a rotating armature of an electric motor, and
a first and second shaft end part, which are arranged on opposing end faces of the rotor centre part and are connected to the rotor centre part in a rotationally engaged manner, wherein a basic shape of the first shaft end part and a basic shape of the second shaft end part are mirror-symmetrical to one another.

2. The rotor according to claim 1, wherein the shape of the first shaft end part and/or the shape of the second shaft end part differ from the respective basic shape only as a result of partial material removal.

3. The rotor according to claim 2, wherein the shape of the first shaft end part and/or the shape of the second shaft end part substantially correspond to the respective basic shape and only differ from the shape of the first shaft end part and the shape of the second shaft end part as a result of surface structures.

4. The rotor according to claim 2, wherein the material removal is caused by balancing.

5. The rotor according to claim 1, wherein the rotor centre part, with the shaft end parts fastened thereto, is substantially mirror-symmetrical.

6. The rotor according to claim 1, wherein
the first and second shaft end parts each have a thread, one of which is a left-hand thread and the other a right-hand thread, and/or
the rotor centre part has two threads, one of which is a left-hand thread and the other a right-hand thread.

7. The rotor according to claim 1, wherein the first and second shaft end parts are configured in such a way that the rotor can be borne on the first and second shaft end parts.

8. The rotor according to claim 1, wherein the first and second shaft end parts each have an axially extending cavity and are configured to be cup-shaped.

9. The rotor according to claim 1, wherein the first and second shaft end parts are configured in such a way that a first impeller and a second impeller can be fastened thereto in a rotationally engaged manner.

10. The rotor according to claim 9, wherein the first and second shaft end parts each have an axially extending cavity and are configured to be cup-shaped, and
wherein the first impeller is connected to the first shaft end part or the rotor centre part by a first tie bar projecting into the cavity, and/or the second impeller is connected to the second shaft end part or the rotor centre part by a second tie bar projecting into the cavity.

11. The rotor according to claim 9, further comprising a compressor wheel as a first impeller, which is arranged on the first shaft end part, and a turbine wheel as a second impeller, which is arranged on the second shaft end part.

12. The rotor according to claim 9, further comprising a first compressor wheel as a first impeller, which is arranged on the first shaft end part, and a second compressor wheel as a second impeller, which is arranged on the second shaft end part.

13. The rotor according to claim 3, wherein the material removal is caused by balancing.

14. The rotor according to claim 1, wherein the shape of the first shaft end part and/or the shape of the second shaft end part correspond to the respective basic shape.

15. The rotor according to claim 14, wherein the shape of the first shaft end part and/or the shape of the second shaft end part substantially correspond to the respective basic shape and only differ from the shape of the first shaft end part and the shape of the second shaft end part as a result of surface structures.

16. A supercharger arrangement for supplying air in a fuel cell system, the supercharger arrangement comprising a rotor according to claim 1.
